(19) United States
(12) Patent Application Publication
(10) Pub. No.: US 2005/0039565 A1
(43) Pub. Date: Feb. 24, 2005

(54) Ergonomic handgrip with medical benefits

(76) Inventors: Roger Minkow, Petaluma, CA (US); Andrew Farquharson, El Cerrito, CA (US); Robert Egger, Watsonville, CA (US)

Correspondence Address: THOMPSON & KNIGHT L.L.P.;PATENT PROSECUTION DEPARTMENT, 98 SAN JACINTO BLVD., SUITE 1900, AUSTIN, TX, 78701, US

(21) Appl. No.: 10/817,452

(22) Filed: Apr. 2, 2004

Related U.S. Application Data
(60) Provisional application No. 60/460,102, filed on Apr. 2, 2003.

(51) Int. Cl. B62K 21/26

(52) U.S. Cl. 74/551.9

(57) ABSTRACT

An ergonomic handgrip with medical benefits for improving the design of handgrips such that they reduce fatigue and offer other features that are of real medical benefit to the user. Our invention reduces this to practice with an ergonomic handgrip that offers motorcycle riders improved control over the steering/throttle mechanism, and that mitigates ulnar neuropathy, including related numbness. In addition, it allows the rider additional hand leverage on the throttle, thereby reducing the pressure required to operate it. This invention can be applied to a broad range of products, improving handgrips in fields such as recreation, machine operation and, as in the motorcycle handgrip, transportation. The inventive device includes novel features that are not found in the prior art. The first component is an outward protrusion of the rear portion of the grip, that is positioned towards the portion of the palm that lies under the fourth and fifth (ring and pinkie) fingers. This disperses pressure over Guyon's Canal (Ulnar Canal). The second component is an outward protrusion of the front portion of the grip, which may be positioned under the index, middle, ring and pinkie fingers. The protrusions of the front and rear portions increase the diameter of the grip itself, and improve the leverage of the handgrip. An inward curve of the grip under the thumb area may optionally be provided.

### CROSS REFERENCE TO RELATED APPLICATION

This application claims the benefit of U.S. Provisional Application No. 60/460,102, filed Apr. 2, 2003, the contents of which are incorporated herein by reference.

### FIELD OF THE INVENTION

The present invention relates generally to handgrips and more specifically to an ergonomic handgrip that offers features that are of medical benefit to the user.

### BACKGROUND OF THE INVENTION

It can be appreciated that handgrips have been in use for years. Typically, handgrips are comprised of a broad assortment of grips that are found on motorcycles and other devices. In addition, a number of patents have been filed on handgrip inventions that claim to offer ergonomic benefit. The closest prior art that we have identified are found in patent numbers: U.S. Pat. No. 5,979,015, U.S. Pat. No. 5,440,784, U.S. D Pat. No. 459,645, and U.S. Pat. No. 5,819,594.

Conventional handgrips are not believed to adequately address the most common problems associated with riding. Motorcyclists are prone to certain problems related to the manner in which they hold, throttle, and steer the vehicle. The most common problems are believed to be grip fatigue and ulnar neuropathy. Traditional motorcycle handgrips are symmetrical cylinders, which offer poor vibration dampening, do not increase the leverage of the hand on the axis of motion, are not comfortable, and do not minimize ulnar pressure.

Another problem with conventional handgrips is that none of the patented inventions are believed to be designed with medical benefit in mind. The best of the patents in this area are believed to attempt to tailor the shape of the grip such that it accommodates the natural shape of the human hand. It is believed that this approach aggravates compression of the ulnar nerve, and does not optimize distribution of pressure across the hand.

While these conventional devices may be suitable for the particular purpose to which they address, it is believed that they are not as suitable for improving the design of handgrips such that they reduce fatigue and offer other features that are of real medical benefit to the user.

### SUMMARY OF THE INVENTION

In view of the foregoing disadvantages in the known types of handgrips now present in the prior art, a need has therefore arisen for an ergonomic handgrip with medical benefits to the user. Our invention reduces this to practice with a handgrip that offers motorcycle riders improved control over the steering/throttle mechanism, and that mitigates ulnar neuropathy, including related numbness. In addition, it increases hand leverage on the throttle, thereby reducing the pressure required to operate it. This invention can be applied to a broad range of products, improving handgrips in fields such as recreation, machine operation, and transportation.

In these respects, the ergonomic handgrip with medical benefits according to the present invention substantially departs from the conventional concepts and designs of the prior art, and in so doing provides an apparatus primarily developed for the purpose of improving the design of handgrips such that they reduce fatigue and offer other features that are of real medical benefit to the user.

The general purpose of the present invention, which will be described subsequently in greater detail, is to provide a new ergonomic handgrip with medical benefits that has many of the advantages of the handgrips mentioned heretofore and many novel features that result in a new ergonomic handgrip with medical benefits which is not anticipated, rendered obvious, suggested, or even implied by any of the prior art handgrips, either alone or in any combination thereof.

To attain this, the present invention generally comprises novel features that are not found in the prior art. An outward protrusion or extension of the rear portion of the grip is provided that is positioned toward the portion of the palm that lies under the 4th and 5th (ring and pinkie) fingers. This disperses pressure over Guyon's Canal (Ulnar Canal). Also provided is an outward protrusion or extension of the front portion of the grip, which is positioned under the four fingers. The protrusions of the front and rear portions increase the diameter of the grip itself, and improve the leverage of the handgrip. This wider diameter may be variable along the length of the handgrip. In addition, an inward curve of the grip under the thumb area may optionally be provided.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an ergonomic handgrip with medical benefits that will overcome the shortcomings of the prior art devices.

An object of the present invention is to provide an ergonomic handgrip with medical benefits for improving the design of handgrips such that they reduce fatigue and offer other features that are of real medical benefit to the user.

Another object is to provide an ergonomic handgrip with medical benefits that reduces rider fatigue, due to holding the hand on the handgrip, or manipulating a throttle via the grip.

Another object is to provide an ergonomic handgrip with medical benefits that allows the rider to hold, steer and throttle the motorcycle without having to squeeze and maintain uncomfortable pressure on the grip.

Another object is to provide an ergonomic handgrip with medical benefits that minimizes ulnar neuropathy and related numbness in the hand of the rider.

Another object is to provide an ergonomic handgrip with medical benefits that decreases the pressure required to open and manipulate the throttle of the motorcycle.

Another object is to provide an ergonomic handgrip with medical benefits that presents a breakthrough in handgrip design that can be applied across a wide variety of industries, including but not limited to: recreational sports, industrial applications, transportation, etc.

Another object is to provide an ergonomic handgrip with medical benefits that improve the comfort of the grip.

Another object is to provide an ergonomic handgrip with medical benefits that offers benefit to all types of riders, or to anyone employing one of our inventions, be it on a motorcycle, bicycle, tennis racket, gear shift lever, or any other device that incorporates our designs.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a top view of a pair of handgrips in accordance with one embodiment of the present invention.

FIG. 2 depicts a cross-sectional view of the handgrips of FIG. 1.

FIG. 3 depicts a front view of the handgrips of FIG. 1.

FIG. 4 depicts a perspective view of the handgrips of FIG. 1.

FIG. 5 depicts a perspective view of the handgrips of FIG. 1.

FIG. 6 depicts another perspective view of the right handgrip of FIG. 1.

FIG. 7 depicts an end view of the right handgrip of FIG. 1.

FIG. 8 depicts a motorcycle handgrip assembly incorporating the right handgrip of FIG. 1.

### DETAILED DESCRIPTION OF THE INVENTION

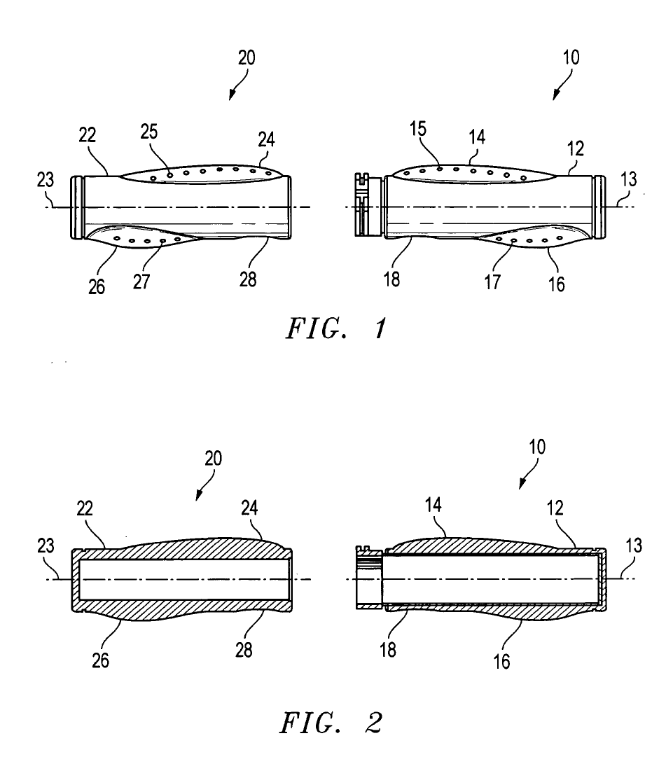

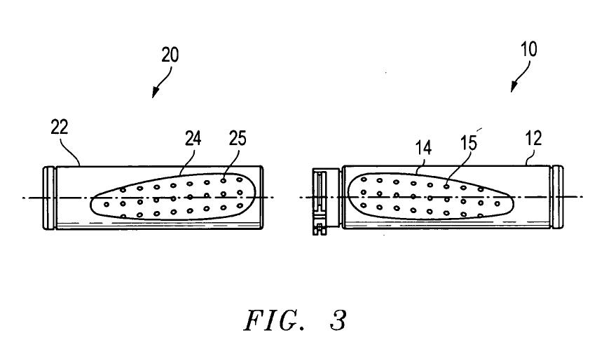

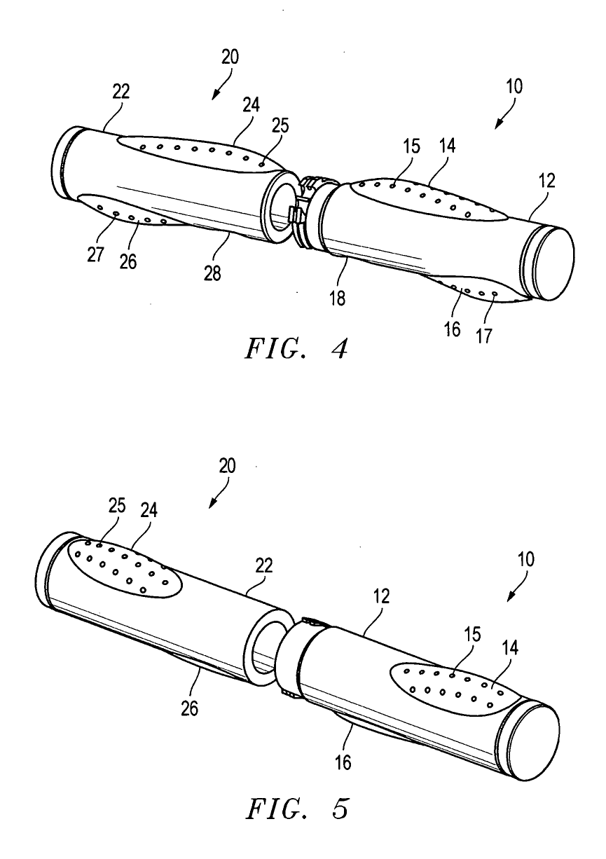

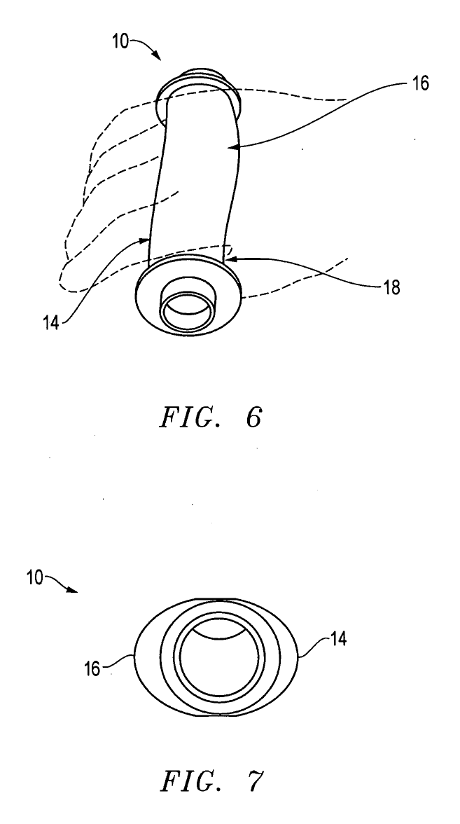

Reference is now made to FIGS. 1-5, which depict a right handgrip 10 (also referred to as the throttle grip) and a left handgrip 20 in accordance with one embodiment of the present invention.

The right handgrip 10 comprises a generally tubular body 12 having a horizontal midline 13, and the left handgrip 20 comprises a generally tubular body 22 having a horizontal midline 23. Unlike conventional symmetrical cylinders, each of the handgrips 10 and 20 is characterized by an asymmetrical design which will be discussed in further detail below.

An outward protrusion 14 of the front portion of the right handgrip 10 is provided, which is positioned under the fingers of the right hand of the rider. For example, the outward protrusion 14 may be positioned under the index, middle, ring, and pinkie fingers (i.e., the second, third, fourth, and fifth fingers) of the right hand. Likewise, an outward protrusion 24 of the front portion of the left handgrip 20 is positioned under the fingers of the left hand of the rider, such as the second, third, fourth, and fifth fingers. Variations of protrusions 14 and 24 may include any design or product that offers extra padding, whatever the material, to the fingers.

The protrusions 14 and 24 are located on the finger side or “forward side” of each handgrip 10 and 20, respectively, on the side opposite the rider. The protrusions 14 and 24 are tapered and angled upward beginning at the midline 13 or 23, respectively. The taper and angle of the protrusions 14 and 24 provide comfort and medical benefits to the rider.

In addition, the protrusion 14 on the right handgrip 10 allows the fingers of the rider's right hand to pull upward, opening the throttle without having to tightly grasp around the right handgrip 10.

Concave pits 15 and 25 may optionally be provided on the surface of the protrusions 14 and 24, respectively.

An outward protrusion 16 of the rear portion of the right handgrip 10 is provided, that is positioned toward the portion of the palm that lies under the 4th and 5th (ring and pinkie) fingers of the right hand of the rider. Likewise, an outward protrusion 26 of the rear portion of the left handgrip 20 is provided, that is positioned towards the portion of the palm that lies under the 4th and 5th (ring and pinkie) fingers of the left hand of the rider. The protrusions 16 and 26 disperse pressure over Guyon's Canal (Ulnar Canal).

The protrusions 16 and 26 (“Palm Protrusions”) may comprise vibration dampening or other suitable material, which disperses pressure over Guyon's Canal (Ulnar Canal). The protrusions 16 and 26 are comfortable to the hands. Variations of palm protrusions 16 and 26 may include any design or product that offers extra padding, whatever the material, to the palm, or that would mediate pressure of Guyon's Canal in any way.

In addition, the protrusion 16 on the right handgrip 10 advantageously allows the rider's right hand to push downward, opening the throttle without having to tightly grasp around the right handgrip 10.

Concave pits 17 and 27 may optionally be provided on the surface of the protrusions 16 and 26, respectively.

The composition of the handgrips 10 and 20 may be selected from various materials, such as rubber, chrome, plastic, or other suitable material, or a combination of any of the foregoing.

Ulnar neuropathy caused by riding a motorcycle is the result of compression of the ulnar nerve against the hamate bone. This happens because a conventional round grip concentrates pressure at the apex of the curvature of the grip. By practicing the present invention, the pressure load is dispersed more evenly, and the top surface of the grip is flattened to some extent, thus reducing the pressure concentration and reducing the ulnar neuropathy.

Thus, an effect of the forward protrusions 14 and 24 and rear protrusions 16 and 26 is to provide a larger top surface. By having a larger, flatter surface, the pressure on the ulnar nerve in the Guyon's Canal is reduced. Pressure on the Guyon's Canal is also alleviated by how the front and, especially, rear protrusions change the position of the hand on the grip. These protrusions turn the wrist slightly outwards, thereby relieving tension on the ulnar nerve.

A throttle can be controlled more efficiently using this asymmetric design. Instead of squeezing a conventional throttle to control it, the throttle can now be controlled by pulling up on the front extension 14, or pushing down on the rear extension 16, or both. Because of the ability to control the throttle in different ways, the rider is able to shift between pulling up and pushing down. This benefits the rider by relieving hand and forearm tension.

In addition, extending the throttle in the front and rear increases the lever angle while twisting. This allows more accurate control of the throttle with finer movements. Having the front and rear extensions of the throttle advantageously allows the rider to sense the position of the throttle and how open it is. A traditional cylindrical grip provides no positional sense.

An inward curve or tapered recessed portion 18 under the thumb area of the right handgrip 10 may optionally be provided, allowing the thumb angle to settle onto the handgrip 10 close to the inward cylinder of the grip. Likewise, an inward curve or tapered recessed portion 28 under the thumb area of the left handgrip 20 may also be provided. The inward curves 18 and 28 provide a smaller circumference and a more comfortable place for the thumb to grasp the handgrip. Variations of the inward curve 18 and 28 may include any design or product that mediated or in some other way addressed the way in which the thumb and/or its surrounding area in the hand touched the handgrip. The inward curve 18 is also illustrated in FIG. 6, which depicts the right handgrip 10 relative to a person's right hand. In addition, as shown in FIG. 6, the handgrip 10 does not need to have any concave pits 15 or 17.

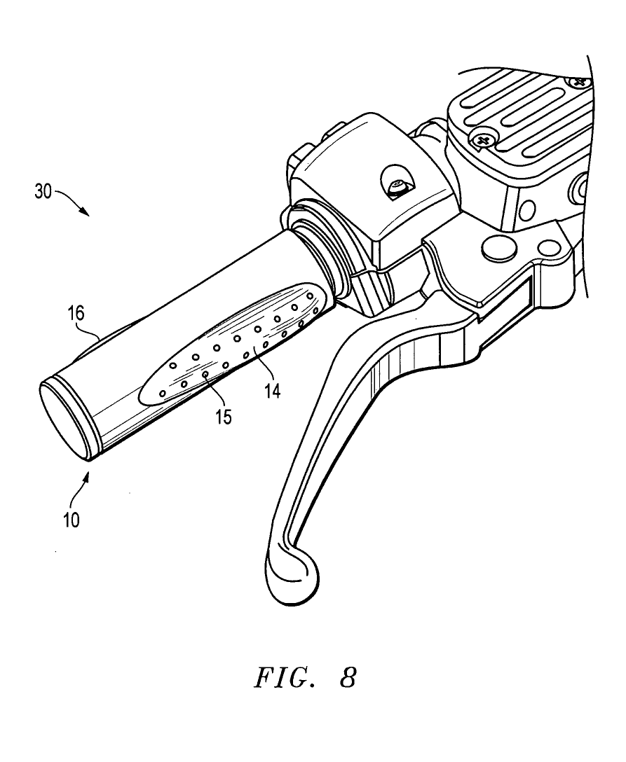

As shown in FIG. 7, an increase in the diameter of the handgrip is provided, which improves the leverage of the handgrip. The handgrip geometry incorporates a wider diameter, designed for improved leverage. The handgrips 10 and 20 are wider than traditional designs, enabling improved leverage of the hand motion relative to the axis of throttle motion. In addition, the wider handgrip incorporates other design elements, such as the ones outlined above, that offer ergonomic benefit to the user. The wider diameter of the handgrip addresses the primary leverage points of the hand, as described above. Variations may include any design or product that modified the diameter of the handgrip in any way.

FIG. 8 depicts a motorcycle throttle handgrip assembly 30 incorporating the right handgrip 10 of FIGS. 1-5. The handgrip 10 may be, but need not be, co-molded with the throttle tube.

All of the components of the present invention may be manufactured together into the final handgrip, such that they all connect with each other seamlessly, from the perspective of the user. Alternative variations of our invention would include the components in different positions on the handgrip, of any material(s), of different shapes, or geometries and otherwise designed in other ways that offer the same benefits claimed herein. In addition, variations would include any designs that included one or more of the features, in whatever form or variation, whatever their material.

Thus, it will be appreciated that the present invention allows a handgrip user, such as a motorcycle rider, to reduce his or her fatigue, and reduce ulnar neuropathy, and operate his or vehicle or device by manipulating the handgrip more easily. The invention achieves these aims by a design that improves the standard, traditional handgrip—making a new version that does not require any additional learning on the part of the user. The components of the present invention enable all of the benefits described elsewhere in this filing.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as exemplary embodiments. Various changes may be made in the shape, size, and arrangement of parts. For example, equivalent elements or materials may be substitute for those illustrated and described herein, and certain features of the invention may be utilized independently of the use of other features, all as would be apparent to one skilled in the art after having the benefit of this description of the invention. In addition, the words “a” are “an” do not preclude the presence of a plurality of elements accomplishing the same function.

1. A throttle handgrip for use with a motorcycle, the throttle handgrip comprising:
a generally tubular body having a horizontal midline;
a first tapered protrusion disposed on a forward side of the generally tubular body, on which a person's fingers can rest; and
a second tapered protrusion disposed on a rear side of the generally tubular body, on which the person's palm can rest;
wherein the first tapered protrusion has a midline at an angle to the horizontal midline; and
wherein the first tapered protrusion and the second tapered protrusion reduce ulnar neuropathy by relieving tension on the person's ulnar nerve.

2. The throttle handgrip as claimed in claim 1, wherein the first tapered protrusion is positioned for accommodating the person's second, third, fourth, and fifth fingers.

3. The throttle handgrip as claimed in claim 1, wherein the second tapered protrusion is positioned for accommodating a portion of the person's palm that lies under the person's fourth finger and fifth finger.

4. The throttle handgrip as claimed in claim 1, wherein the generally tubular body includes a tapered recessed portion for accommodating the person's thumb.

5. The throttle handgrip as claimed in claim 1, wherein the handgrip is comprised of rubber.

6. The throttle handgrip as claimed in claim 1, wherein the handgrip is comprised of plastic.

7. The throttle handgrip as claimed in claim 1, wherein the handgrip is comprised of chrome.

8. A handgrip comprising:
a generally tubular body having a horizontal midline;
a first tapered protrusion disposed on a forward side of the generally tubular body, on which a person's fingers can rest; and
a second tapered protrusion disposed on a rear side of the generally tubular body, on which the person's palm can rest;
wherein the first tapered protrusion has a midline at an angle to the horizontal midline; and
wherein the first tapered protrusion and the second tapered protrusion reduce ulnar neuropathy by relieving tension on the person's ulnar nerve.

9. The handgrip as claimed in claim 8, wherein the first tapered protrusion is positioned for accommodating the person's second, third, fourth, and fifth fingers.

10. The handgrip as claimed in claim 8, wherein the second tapered protrusion is positioned for accommodating a portion of the person's palm that lies under the person's fourth and fifth fingers.

11. The handgrip as claimed in claim 8, wherein the generally tubular body includes a tapered recessed portion for accommodating the person's thumb.

12. The handgrip as claimed in claim 8, wherein the handgrip is comprised of rubber.

13. The handgrip as claimed in claim 8, wherein the handgrip is comprised of plastic.

14. The handgrip as claimed in claim 8, wherein the handgrip is comprised of chrome.

15. The handgrip as claimed in claim 8, wherein the handgrip is for use with a motorcycle.

16. A method for controlling a throttle of a motorcycle, the method comprising the steps of:
opening the throttle by pulling upward on a first tapered protrusion of a handgrip; and
opening the throttle by pushing downward on a second tapered protrusion of the handgrip;
wherein the first tapered protrusion is positioned for accommodating a person's second, third, fourth, and fifth fingers;
wherein the second tapered protrusion is positioned for accommodating a portion of the person's palm that lies under the person's fourth and fifth fingers;
wherein the first tapered protrusion has a midline at an angle to a horizontal midline of the handgrip; and
wherein the first tapered protrusion and the second tapered protrusion reduce ulnar neuropathy.

17. A method of reducing ulnar neuropathy resulting from operating a motorcycle handgrip, the method comprising the steps of:
providing a motorcycle handgrip comprising:
a generally tubular body having a horizontal midline;
a first tapered protrusion disposed on a forward side of the generally tubular body, on which a person's second, third, fourth, and fifth fingers can rest; and
a second tapered protrusion disposed on a rear side of the generally tubular body, on which a portion of the person's palm can rest;
wherein the first tapered protrusion has a midline at an angle to the horizontal midline; and
wherein the first tapered protrusion and the second tapered protrusion reduce ulnar neuropathy by relieving tension on the person's ulnar nerve.
